(19) United States
(12) Patent Application Publication
(10) Pub. No.: US 2007/0271383 A1
(43) Pub. Date: Nov. 22, 2007

(54) Method and system for managing an electrical device over a power delivery network

(75) Inventors: Nathaniel W. Kim, Raleigh, NC (US); Charles S. Lingafelt, Durham, NC (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/436,237

(22) Filed: May 18, 2006

(51) Int. Cl. G06F 15/173; G06F 15/16

(52) U.S. Cl. 709/227; 709/223

(57) ABSTRACT

Under the present invention, a data networking protocol is applied over a power delivery network to manage an electrical device. In a typical embodiment, the data networking protocol is 802.1X. To this extent, the present invention utilizes different configurations of a location component/function, an identification component/function (also known in the art as a “supplicant function”), an authentication component/function, and an authentication server to authenticate and manage power delivery to the electrical device.

### CROSS-REFERENCE TO RELATED APPLICATIONS

This application is related in some aspects to the commonly assigned and co-pending application identified by attorney docket number END920050100US1, assigned U.S. application Ser. No. (to be provided), entitled “System and Method for Disabling an Electrical Device”, and filed (to be provided) the entire contents of which are herein incorporated by reference. This application is also related in some aspects to the commonly assigned and co-pending application identified by attorney docket number END920050143US1, assigned U.S. application Ser. No. (to be provided), entitled “Method and System for Calibrating an Electrical Device”, and filed (to be provided) the entire contents of which are herein incorporated by reference.

### BACKGROUND OF THE INVENTION

1. Field of the Invention

The present invention generally provides a method and system for managing an electrical device over a power delivery network. Specifically, the present invention applies a data networking protocol (i.e., 802.1X) over a power delivery network to control an electrical device and obtain information about the device.

2. Related Art

Within most organizations, there exists a need to identify and track physical re-locatable electrical devices/assets (e.g., medical equipment, computers, printers, photocopiers, etc.) that draw energy from the organization's power delivery network and to obtain device attribute information. In some cases, it is desirable that an electrical device no longer function when it is removed from the premises (e.g., theft deterrence). The ability to track and enable/disable such electrical devices could provide many advantages such as inventory management, device control, etc.

Unfortunately, no existing approach provides a cohesive solution to device management. That is, existing approaches involve a litany of disparate systems that fail to truly or seamlessly integrate with one another. As such, existing approaches fail to integrate the concepts of identification and location in managing an electrical device.

In view of the foregoing, there exists a need to overcome the above-cited deficiencies in the prior art.

### BRIEF SUMMARY OF THE INVENTION

In general, the present invention provides a method and system for managing an electrical device over a power delivery network. The present invention further provides an electrical device capable of being managed over a power delivery network. Specifically, the present invention applies a data networking protocol used by the electrical device, such as 802.1X, over a power delivery network. This allows identification and authentication of the electrical device to be performed over the power delivery network.

A first aspect of the present invention provides a method and system for managing an electrical device over a power delivery network. Under this aspect, a query is received in an identification component located within the electrical device from an authentication component located within the electrical device. In response to the query, at least one attribute is provided from the identification component to the authentication component. Under the present invention, the at least one attribute can include an identity of the electrical device, credentials for the electrical device, and/or a location of the electrical device. If a location is included, the location will be determined by a location component contained within the electrical device (e.g., a Global Positioning System (GPS) unit, an input device such as a key pad or switch), and provided to the identification component. In any event, the at least one attribute will be provided from the identification component to the authentication component, and then provided from the authentication component to an authentication server over the power delivery network. Using the information, the authentication server can attempt to authenticate the device. If authenticated, the electrical device can then be activated over the power delivery network. Results of the authentication as well as information for the electrical device can be stored in a device's information database for future access and/or reference.

A second aspect of the present invention provides another method and system for managing an electrical device over a power delivery network. Under this aspect, a query is received within an identification component located within the electrical device from an authentication component located within the power delivery network. In response, an identity of the electrical device is provided from the identification component to the authentication component. Thereafter, the identity of the electrical device and an identity of a power socket of the power delivery network to which the electrical device is connected is provided from the authentication component to an authentication server over the power delivery network. In this aspect of the invention, the authentication component is located within the power socket, and a location component is contained on the authentication server. The location component will determine a location of the power socket using its identity by accessing a power socket location database that associated power socket identities with locations. Since the electrical device is connected to the power socket via a power cord of finite length, the two are considered to be co-located. In any event, the electrical device will be authenticated on the authentication server based on the location and the identity of the electrical device. Upon authentication, the electrical device will be activated over the power delivery network. Similar to the first aspect, a result of the authenticating as well as information for the electrical device can be stored in a devices information database.

The present invention also provides an electrical device capable of being managed over a power delivery network. Such an electrical device will incorporate some or all of the components discussed above. Still yet, the identification component, location component and/or the authentication component can be implemented as hardware, software or a combination of hardware and software. For example, any or all of these components could be implemented as program code of a program product that is stored that is on a computer useable medium.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts electrical devices connected to a power delivery network according to the prior art.

FIG. 2 depicts 802.1X port-based authentication according to the prior art.

FIG. 3A depicts the management of an electrical device over a power delivery network according to one embodiment of the present invention.

FIG. 3B depicts physical and logical views of the embodiment of FIG. 3A.

FIG. 4 depicts a diagram of an electrical device according to the embodiment of FIGS. 3A-B.

FIG. 5 depicts an operation flow diagram of the embodiment of FIGS. 3A-B and 4.

FIG. 6 depicts a method flow diagram according to the embodiment of FIGS. 3A-B and 4.

FIG. 7A depicts the management of an electrical device a power delivery network according to another embodiment of the present invention.

FIG. 7B depicts physical and logical views of the embodiment of FIG. 7A.

FIG. 8 depicts a diagram of an electrical device and a power socket according to the embodiment of FIGS. 7A-B.

FIG. 9 depicts an operation flow diagram of the embodiment of FIGS. 7A-B and 8.

FIG. 10 depicts a method flow diagram according to the embodiment of FIGS. 7A-B and 8.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE DRAWINGS

The invention applies to electrical devices that are connected to a power delivery network, such as an AC power delivery system, found in virtually all buildings. This invention enhances the power delivery network to dynamically identify an electrical device that is “plugged” into a power socket, identify the location of the electrical device and optionally control the application of power to the electrical device at the power socket.

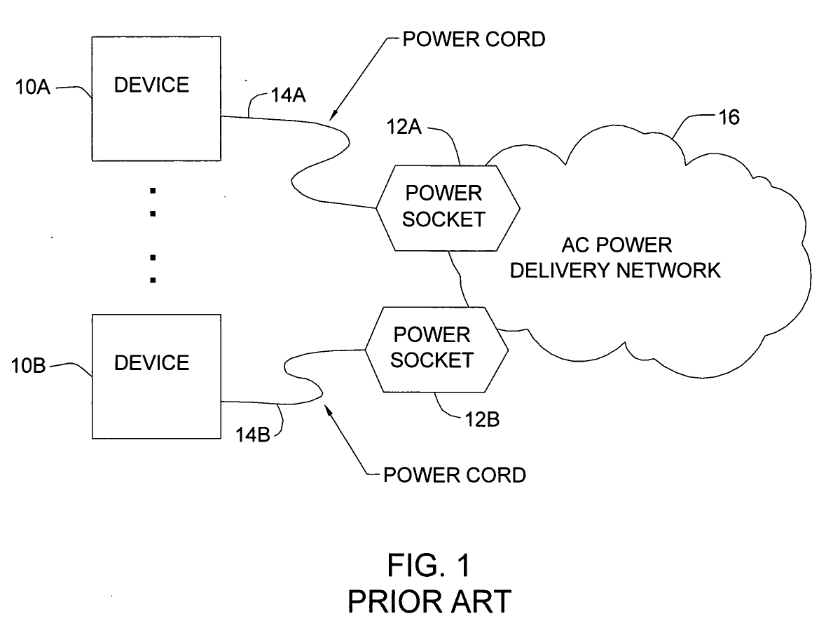

Referring now to FIG. 1, the connection of electric devices 10A-B to a power delivery network 16 according to the prior art is shown. As depicted, electric devices 10A-B connect to power delivery network 16 through power sockets 12A-B and power cords 14A-B. As will be further described below, the present invention will apply a data networking protocol to power delivery network 16 to provide management of electric devices 10A-B.

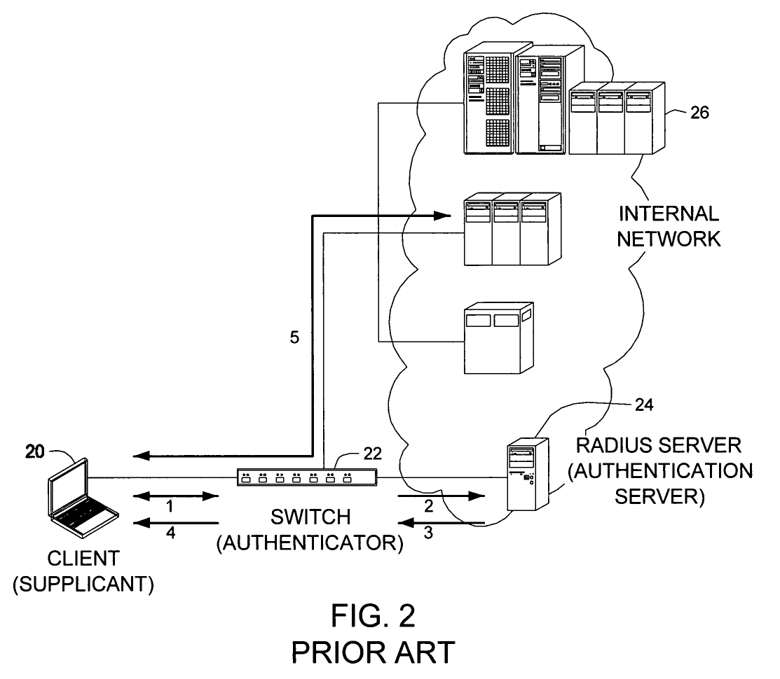

In a typical embodiment, the data networking protocol that is applied to power delivery network 16 is 802.1X, which is also known as port-based network access control. This networking protocol is currently an I.E.E.E. standard for identification and authentication of a device at an authentication (function) component that is typically a switch port. Referring to FIG. 2, an implementation of 802.1X for authentication a client device 20 (also referred to the art as “supplicant”) is shown. Specifically, in a Local Area Network (LAN) where 802.1X is enabled, the switch (authentication component) 22 challenges client device 20 for its identity to validate that it (or its user) is authorized to access data network 26. Switch 22 then sends the supplied information to an authentication server 24, which is typically a Remote Authentication Dial-In User Service (RADIUS) server, for actual authentication of the client device 20. The authentication server 24 responds to switch 22 with a response. If client device 20 is an authorized user, the switch puts the client's port in authenticated and forwarding state. Switch 22 then relays the authentication result to client device 20. Once client device 20 is authenticated and the port is in authorized state, client device 20 can access network 26 resources. If the authentication is not successful, switch 22 keeps the port closed and no network traffic will pass through. The present invention will apply these concepts to manage (e.g., control) electric devices over a power delivery network.

### Embodiment A

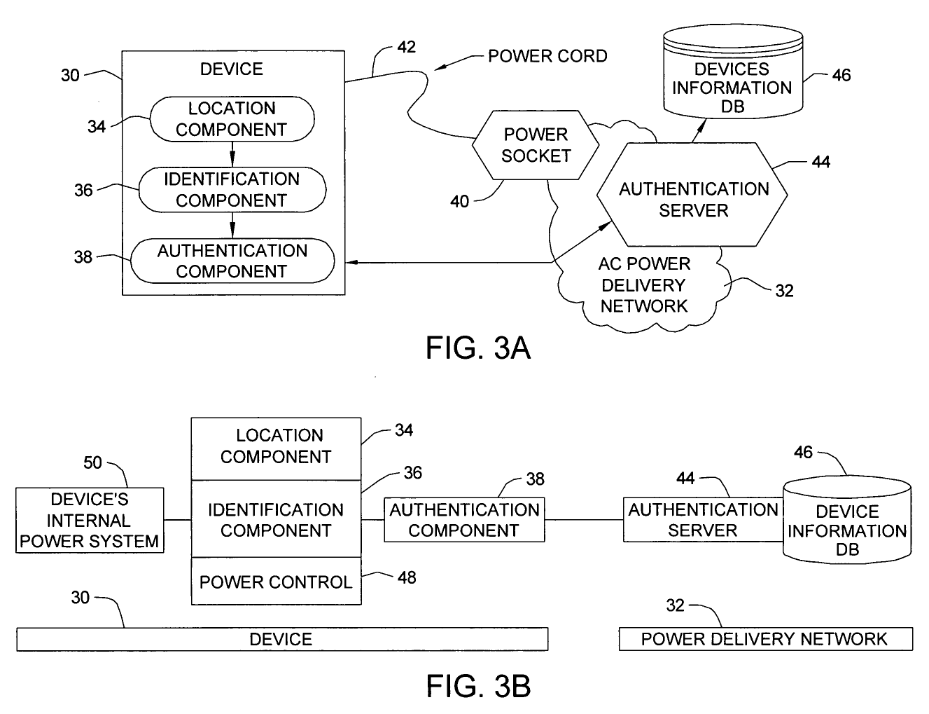

Referring to FIG. 3A, a first embodiment for managing an electric device 30 over (AC) power delivery network 32 according to the present invention is shown. It should be understood that electrical device 30 could be any type of electrical device now known or later developed. Examples include non-data processing devices such as printers, medical equipment, etc., and data processing devices such as computers. In any event, the embodiment shown in FIG. 3A requires no modification to power delivery network 32, specifically in power socket 40. That is, the underlying functions or components of the present invention are implemented within electrical device 30.

In any event, as shown, electrical device 30 connects to power delivery network 32 through power socket 40 via power cord 42. The functions of each of the features shown in FIG. 3A will be set forth below:

(Optional) Location component/function 34—identifies the location of electrical device 30. To this extent, location component 34 can include a Global Positioning System (GPS) unit, or incorporate triangulation methods based on known radio locations of electrical device 30. Alternatively, location component 34 could be a manual input device such as a key pad, switch, etc. That is, a user could input the location (e.g., office “Y”) into a keypad or the like on electrical device 30.

Identification component/function 36 (also referred to in the art as “supplicant function”)—this is the 802.1X standard supplicant that provides identity of electrical device 30 to the authentication component 38, per the 802.1X protocols. Under the present invention, identification component 36 identifies electrical device 30, and provides its location as provided by location component 34, to authentication component 38. As will be further described below, this identify of electrical device 30 can be obtained by identification component 36 from a variety of sources.

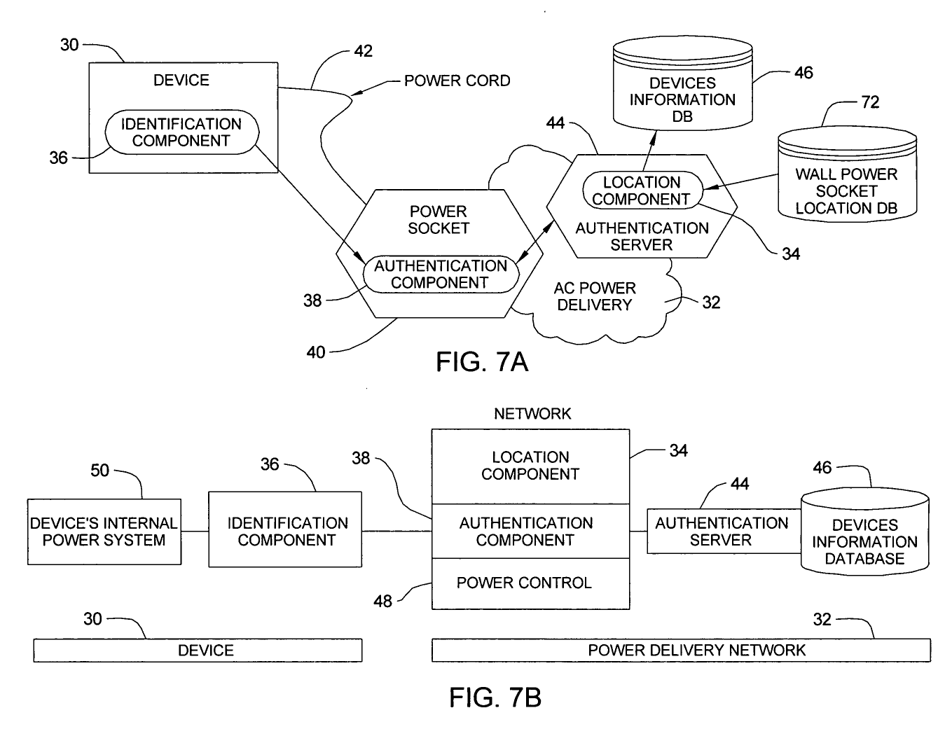

Power socket 40—in this embodiment, this a standard power socket that allows connection of power cord 42 into power delivery network 32. In another embodiment shown in FIG. 7A, power socket 40 is built with a power switch that can be “shut off” by the authentication component 38 if electrical device 30 fails identification and authentication.

Authentication component/function 38—this is the 802.1X standard authentication function that forwards the electrical device 30's identity, credentials and access request to an authentication server 44, then acts on the commands from authentication server 44. In the embodiment of FIG. 3A, the command from authentication server 44 would cause electrical device 30 to connect to power delivery network 32. In the other embodiment to be discussed below, the authentication result could cause power socket 40 (FIG. 7A) to “shut off” its power switch if the authentication fails. In this other embodiment, with successful identification and authentication of electrical device 30, power socket 40 would continue to supply power to electrical device 30.

Authentication server 44—this is the 802.1X standard authentication server that, given the identity (and optionally credentials) which represent electrical device 30's request for power, determines if the device 30 should become energized. This decision is sent to the authentication component 38 for action.

(AC) Power delivery network 32—this represents an AC power system (e.g., in a building) that distributes power. Access into this system is typically via 120 volt AC sockets.

Device information DB 46—the database function that contains the result of the authentication server 44's process and the association of electrical device 30 with other information. This will generally yield a database with fields such as Device_ID, Device's_Power_Socket_Location, Time_Device_was_energized, Time_Device_was_de-energized, Device's_Power_Consumption, Device_Power_Priority, etc.

Referring to FIG. 3B, physical and logical views of the embodiment of FIG. 3A are shown. Specifically, as shown, electrical device 30 includes location component 34, identification component 36, authentication component 38, power control 48, and internal power system 50. Power delivery network 32 incorporates authentication server 44 and device information database 46 (and the power socket although not shown in FIG. 3B).

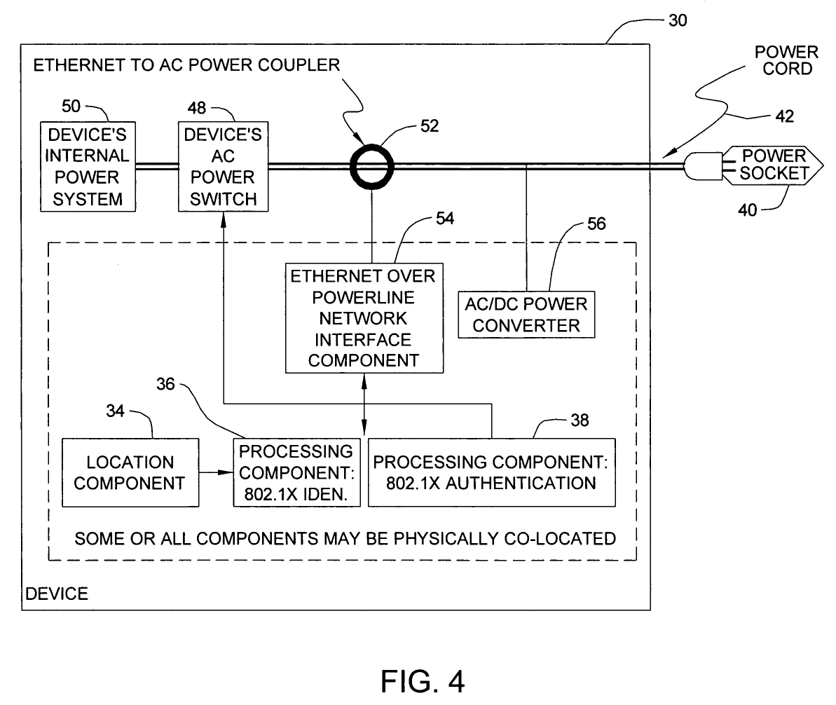

FIG. 4 depicts a more detailed diagram of electrical device 30 according to the embodiment of FIGS. 3A-B. As shown, electrical device 30 includes (optional) location component 34, identification component 36, authentication component 38, power control (AC power switch) 48, internal power system 50, Ethernet to AC power coupler 52, Ethernet over power line network interface component 54, and AC/DC power converter 56. The features of electrical device 30 are defined as follows:

Internal power system 50—the power supply and distribution system within the device.

Power control 48—The component, which under control of the 802.1X supplicant/device 30, connects the AC power from the power cord 42 to the device's internal power system 50. Multiple different physical components could be used (e.g., FETs, relays, digital or analog control signals to the device's AC/DC power supply, etc.). It should be noted that this component's power-up state can disallow power flow from the power cord 42 to internal power system 50. The processing components must command the component to allow power to flow.

Ethernet over power line network interface component 54 and the Ethernet to AC Power Converter (not shown)—these features allow standard Ethernet protocol to flow over a power line.

AC/DC power converter 56—this component provides power to electrical device 30 and is energized immediately when the power cord 42 is connected to the power socket 40.

(Optional) Location component/function 34—as indicated above, this component provides the location of electrical device 30 (i.e., physical location such as office “Y”) to identification component 36 (i.e., in response to a query received by identification component 36 from authentication component 38).

Identification component 36—provides the identity of electrical device 30 (i.e., printer XYZ), as well as the location thereof as received from location component 34 for electrical device 30, to authentication component 38 (i.e., in response to a query received by identification component 36 from authentication component 38). This information can be obtained from a static source such as an embedded chip, an RFID tag, etc. It can also be obtained from a file or the like. Still yet, the identity can be obtained by interactively asking an operator to input the information via a display and buttons or the like. Identification component 36 performs the supplicant function of the 802.1X standard.

Authentication component 38—provides the identity and the location to the authentication server, and receives the command to energize the electrical device 30. This component controls electrical device 30's power control 48. To this extent, authentication component 38 performs the authenticator function of the 802.1X standard.

It should be noted that some or all of the components be combined into the same physical hardware. For example, identification component 36 and authentication component 38 could co-exist on the same physical processor. In addition, the authentication server is not shown, but should be understood to be attached to the power delivery network via an Ethernet over Power line connection. The authentication server then communicates with the authentication component 38 using IP protocols and 802.1X protocols.

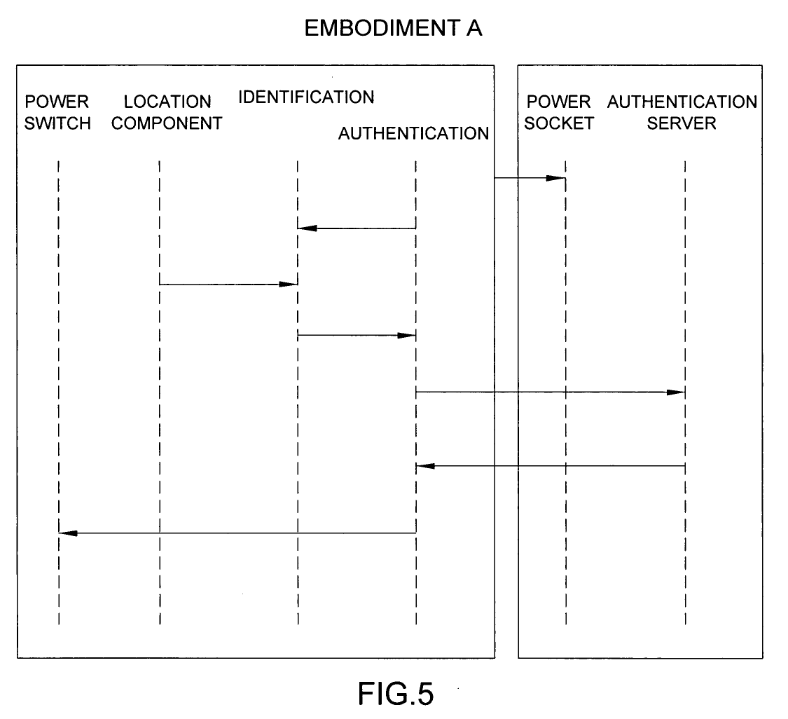

Referring to FIG. 5, an operation flow diagram of the embodiment of FIGS. 3A-B and 4 is shown and will be described in detail. Specifically, under this embodiment, the power cord for the electrical device will be connected to a power socket. Then, the authentication component will challenge the identification component to authenticate the device. This can typically occur via a query generated by and sent from the authentication component to the identification component. In response to the query, at least one attribute of the electrical device will be provided to the authentication component and then to the authentication server. Specifically, the optional location component can provide the location of the electrical device (e.g., a first attribute of the electrical device) to the identification component. In addition, the identification component will provide the identity of the electrical device (e.g., a second attribute of the electrical device) to the authentication component along with the location if received.

In any event, the authentication component will then provide this information to the authentication server, which will attempt to authenticate the device. To this extent, authentication (and subsequent activation) of the electrical device can be based on the identity of electrical device as well its physical location. This allows the power to the device to be managed/controlled based on any number of considerations such as the device's relative importance, power availability, the device's location (e.g., anti-theft), the device's previous workload, the device's calibration status, etc.

Regardless, upon successful authentication of the electrical device, the authentication component will command the power switch for the electrical device to be turned on, thus activating the electrical device. When the power cord is removed, the power switch inside the electrical device will be deactivated. Although not shown in FIG. 5, the authentication server will also store the results of the authentication process in the device information database. It can further associate the electrical device with other information and create corresponding fields in the device information database.

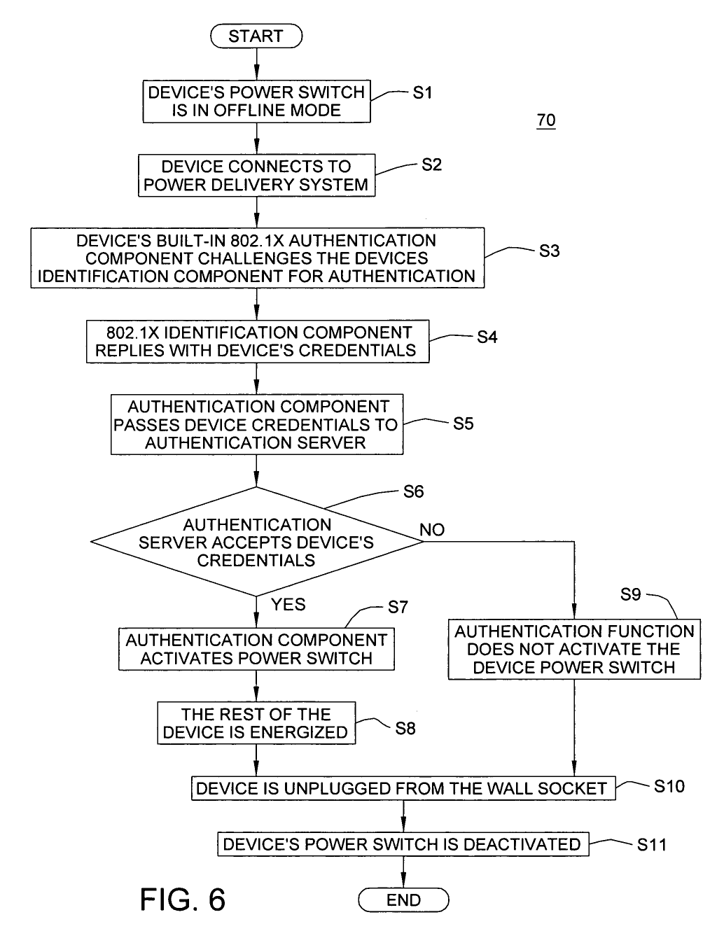

FIG. 6 depicts a method flow diagram 70 according to the embodiment of FIGS. 3A-B and 4. As depicted, in step S1, the electrical device's power switch is in “offline” mode. In step S2, the electrical device connects to the power delivery system. In step S3, the authentication component within the electrical device challenges (e.g., queries) the identification component for authentication. In step S4, the electrical device's identification component replies to the authentication component with at least one attribute of the electrical device. Under the present invention, the attribute(s) can not only include the identity, but also the location of the electrical device. Moreover, the attribute(s) could also include authentication credentials for the electrical device. Although not shown in FIG. 6, the location (if used) will initially be passed to the identification component from the location component located/contained within the electrical device. In any event, in step S5, the authentication component will pass the information to the authentication server. In step S6, it is determined whether the authentication server accepts the electrical device's credentials. If so, the authentication component will activate the electrical device's power switch in step S7, and the electrical device is energized in step S8. However, if the authentication component does not accept the electrical device's credentials, the authentication component will not activate the electrical device, as shown in step S9. In any event, when the electrical is unplugged from the all socket in step S10, its power switch will be deactivated as shown in step S11.

### Embodiment B

Referring now to FIG. 7A, another embodiment for managing an electric device 30 over (AC) power delivery network 32 according to the present invention is shown. In the embodiment shown in FIG. 7A, the optional location component 34 is located on authentication server 44, while authentication component 38 is located within power socket 40 of power delivery network 32. As will be further described below, the location of electrical device 30 will be determined in this embodiment based on the location of power socket 40. Specifically, authentication component 38 will provide an attribute of power socket 40 such as its identity to authentication server 44. Using this information, optional location component 34 on authentication server 44 can determine the physical location of power socket 40 by referencing power socket location database 72, which associates power socket identifications (or other attributes of power socket 40) with their physical locations. Since electrical device 30 is connected to power socket 40 via power cord 42 of finite length, it is presumed that electrical device 30 is generally in the same physical location as power socket 40.

Similar to the first embodiment discussed above, identification component 36 will be queried or challenged by authentication component 38 to provide authentication information for electrical device 30. In response to the query, identification component 36 will provide an attribute of electrical device 30 (e.g., the identity of electrical device) to authentication component 38, which will then provide the attribute of electrical device 30, as well an attribute of power socket 40 (e.g., the identity of power socket 40), to authentication server 44. Authentication server 44 will then authenticate electrical device 30 using the information. Specifically, using the identification of electrical device 30, and the physical location of power socket 40 (e.g., as determined based on the identification of power socket 40 by cross-referencing power socket location database 72), authentication server 44 can attempt to authenticate electrical device 30. If successful, electrical device can be activated (e.g., power can be supplied thereto). It should be understood that other than the physical placement and functional differences discussed herein, the features/components of FIG. 7A will generally have the same functions as set forth above in conjunction with FIG. 3A.

Referring now to FIG. 7B, physical and logical views of the embodiment of FIG. 7A are shown. Specifically, as shown, electrical device 30 includes identification component 36, and internal power system 50. Power delivery network 32 includes optional location component 34, authentication component 38, power control 48, authentication server 44 and device information database 46. Although not shown, power delivery network 32 will also contain power socket database 72.

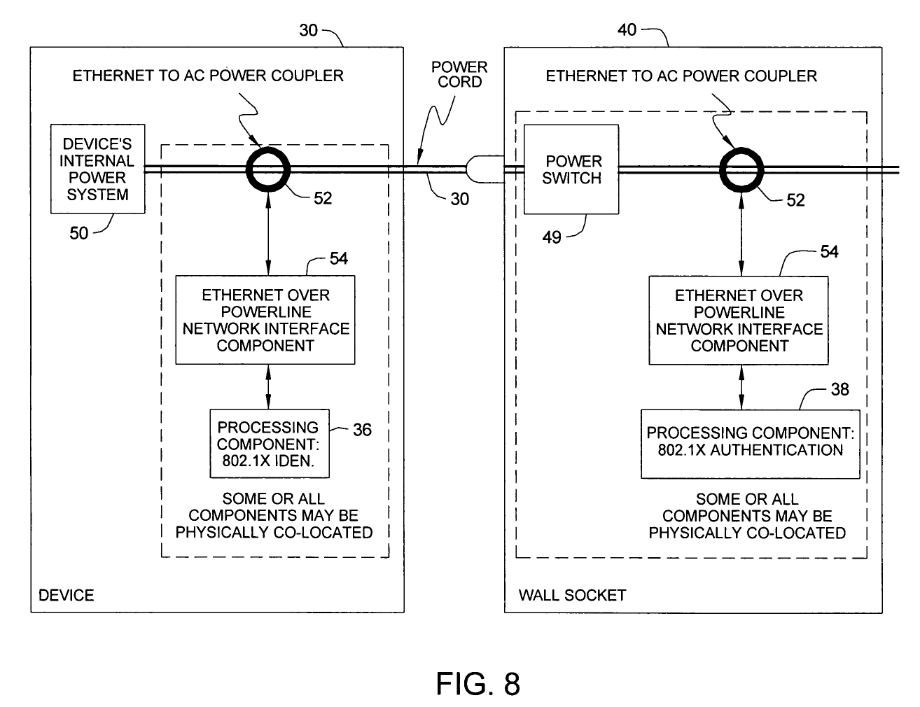

FIG. 8 depicts a more detailed diagram the embodiment of FIGS. 7A-B of the present invention. As shown, electrical device 30 includes identification component 36, authentication component 38, internal power system 50, Ethernet to AC power coupler 52, and Ethernet over power line network interface component 54. Electrical device 30 is connected power socket 40 via power cord 42. As further shown, power socket 40 includes power socket power control (AC power switch) 49, Ethernet to AC power coupler 52, Ethernet over power line network interface component 54, and authentication component 38. As indicated above, location component 34 is contained on authentication server (not shown). Similar to FIGS. 7A-B in relation to FIGS. 3A-B, the features/components of FIG. 8 generally have the same functions as their counterparts in FIG. 4 (excepting any distinctions pointed out herein). For example, power control 49 is located in power socket 40 in FIG. 8, as opposed to in electrical device 30 as shown in FIG. 4. In FIG. 8, power control 49 is the component, which under control of the 802.1X authentication component 38, connects the power cord to the AC power delivery network. Multiple different physical components could be used, e.g., FETs, relays, digital or analog control signals to the power socket's AC/DC power switch, etc. Note that this component's power up state allows power flow from the AC power delivery network to the device's power cord 42. The processing components must command the component to allow power to flow.

It should be noted that some or all of the components be combined into the same physical hardware. For example, identification component 38 and authentication component 38 could co-exist on the same physical processor. In addition, the authentication server is not shown, but should be understood to be attached to the power delivery network via an Ethernet over Power line connection. The authentication server then communicates with the authentication component 38 using IP protocols and 802.1X protocols.

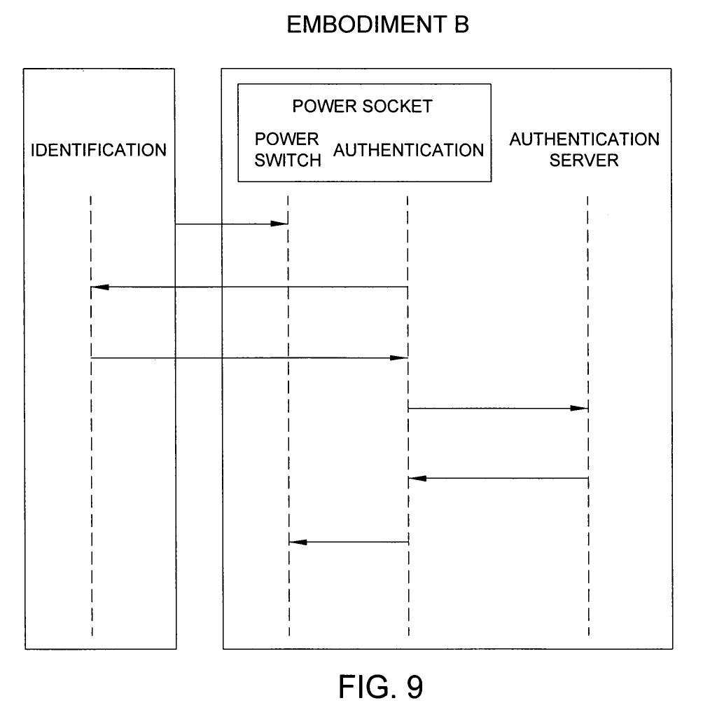

Referring to FIG. 9, an operation flow diagram of the embodiment of FIGS. 7A-B and 8 is shown and will be described in detail. Specifically, under this embodiment, when the power cord for the electrical device is initially connected to a power socket, power is allowed to flow through the power socket. Then, the authentication component will challenge the identification component to authenticate the device. This can typically occur via a query generated by and sent from the authentication component to the identification component. In response to the query, the identification component will provide an attribute (e.g., the identity) of the electrical device to the authentication component. The authentication component will provide this information, along with an attribute (e.g., the identity) of the power socket to the authentication server.

The authentication server will then attempt to authenticate the electrical device using these pieces of information. As indicated above, the location of the power socket can be determined by the location component contained on the authentication server using the power socket's identity by cross-referencing the power socket location database. To this extent, the power socket location database will typically associate the location of power sockets with other attributes thereof such as their identities. In any event, given information, such as the identity of the electrical device and the physical location of the power socket (and the electrical device), authentication of the electrical device based thereon can be attempted. Similar to the embodiment of FIGS. 3A-B, this allows the power to the device to be managed/controlled based on any number of considerations such as the device's relative importance, power availability, the device's location (e.g., anti-theft), the device's previous workload, the device's calibration status, etc. Upon successful authentication of the electrical device, the authentication component will keep the power switch in the power socket “on”. If the authentication fails, the authentication component will turn the power switch in the power socket “off”, and the electrical device will lose power. When the power cord is removed, the power switch inside the electrical device will be activated so that subsequent use of the power socket is enabled. Note that this reactivation of the power socket can be based on a delay if required.

Although not shown in FIG. 9, the authentication server will also store the results of the authentication process in the device information database. It can further associate the electrical device with other information and create corresponding fields in the device information database.

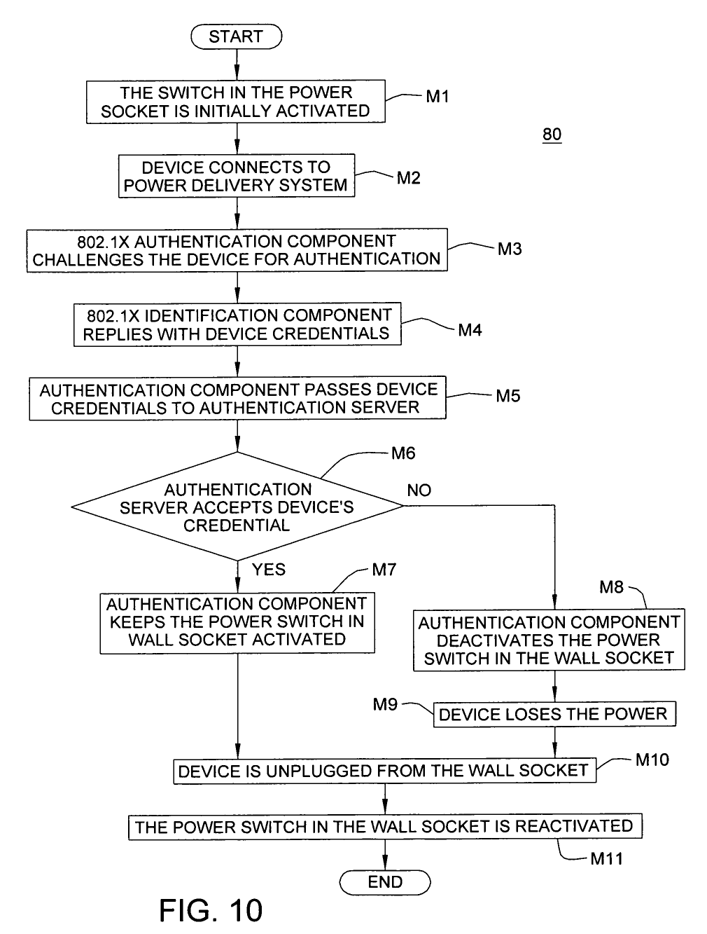

FIG. 10 depicts a method flow diagram 80 according to the embodiment of FIGS. 7A-B and 8. As depicted, in step M1, the power switch in the power socket is initially activated. In step M2, the electrical device connects to the power delivery system. In step M3, the authentication component contained within the power socket challenges/queries the electrical device for authentication. In step M4, the identification component within the electrical device provides the identity of the electrical device to the authentication component, which provides the same along with the identity of the power socket to the authentication server in step M5. In step M6, it is determined whether the authentication server accepts the electrical device's credentials. If so, the authentication component will keep power socket power switch activated in step M7. However, if the authentication component does not accept the electrical device's credentials, the authentication component will deactivate power socket power switch in step M8, and the electrical device will lose power in step M9. In either event, when the electrical device is unplugged from the all socket in step M10, the power switch for the power socket is maintained active or re-activated (depending on the case) in step M11.

Regardless of the embodiment implemented, the present invention results in (among other things) a standard-based database of information about the electrical device(s) that is attached to the power network. Specifically, the device information database, is typically located on the authentication server, and contains records which link the identity of an electrical device with its location and its characteristics. This information enables multiple services to be created that use this information. Shown below is an illustration of devices information database:

| | | | Time_Device_was_de- |
|---|---|---|---|
| Device_ID | Device's_Power_Socket_Location | Time_Device_was_energized | energized |
| 1297 | P1A-5-1- | 07:42:15- | 16:04:02- |
| A098CB | F317/002/RTP | Feb 22-2005 | Feb 22-2005 |
| 8391032 | P3B-8-2- | 09:14:10- | 17:13:05- |
| WW97 | FF004/660/RTP | Feb 22-2005 | Feb 22-2005 |
| Printer- | P94-5-1- | 09:42:10- | -Still on- |
| 04 | GG000/660/RTP | Aug 05- | |
| | | 2004 | |

| Device_ID | Device's_Power_Consumption | Device_Power_Priority | Etc. |
|---|---|---|---|
| 1297 | 0.4 | 2 | Other |
| A098CB | | | |
| 8391032 | 0.5 | 3 | Other |
| WW97 | | | |
| Printer- | 1.8 | 1 | Other |
| 04 | | | |

In general, the present invention leverages information such that as shown in the table above, to manage an electrical device over the power delivery network. For example, the present invention provides physical inventory tracking. That is, by consultation of the devices information database, one can locate the physical assets without the necessity of a physical audit. In addition, the present invention provides for device calibration. Specifically, some electrical device require periodic calibration and in environments in which the electrical device is mobile (e.g., an IV drug dispensing device in a hospital) the locating of the device to perform calibration is problematic. In addition, for usage based calibration requirements, the information in the database could be used to determine when a subject device required calibration.

Still yet, the present invention can provide macro power management. In particular, by data-mining the information in the devices information database, a power usage profile could be created by device, location, (e.g., floor, time of day, day of year, etc.). This information could then be used for global power management. The present invention can also provide micro power management. That is, using the information in the devices information database, the electrical device's power could be turned off remotely if needed, and power could be prevented from being sourced to an electrical device if the device's power consumption would exceed the capacity of the power delivery system. In addition, the present invention can provide theft deterrence. Specifically, if the electrical device's identification component, or also known as supplicant, was configured to require authorization from the authentication server, prior to enabling power to flow to the electrical device, the electrical device would fail to energize without this function. An example of this could be TVs used in a hotel or hospital, in which, if stolen and plugged into a home power source would fail to authenticate and thus would not power up.

While shown and described herein as a method and system for managing an electrical device over a power delivery network, it is understood that the invention further provides various alternative embodiments. For example, in one embodiment, the invention provides a program product stored on a computer-readable/useable medium that includes computer program code to perform the functions of the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, (e.g., a fixed disk, a read-only memory, a random access memory, a cache memory, etc.).

In another embodiment, the invention provides a business method that performs the process steps of the invention on a subscription, advertising, and/or fee basis. That is, a service provider, such as a Solution Integrator, could offer to manage electrical devices over a power delivery network. In this case, the service provider can create, maintain, support, etc., one or more of the features described herein that performs the process steps of the invention for one or more customers. In return, the service provider can receive payment from the customer(s) under a subscription and/or fee agreement and/or the service provider can receive payment from the sale of advertising content to one or more third parties.

As used herein, it is understood that the terms “program code” and “computer program code” are synonymous and mean any expression, in any language, code or notation, of a set of instructions intended to cause a hardware state-machine device or computing device having an information processing capability to perform a particular component either directly or after either or both of the following: (a) conversion to another language, code or notation; and/or (b) reproduction in a different material form. To this extent, program code can be embodied as one or more hardware devices or an application/software program, component software/a library of components, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for managing an electrical device over a power delivery network, comprising:
receiving a query within an identification component located within the electrical device from an authentication component;
providing at least one attribute for the electrical device from the identification component to the authentication component; and
providing the at least one attribute from the authentication component to an authentication server over the power delivery network.

2. The method of claim 1, wherein the at least one attribute comprises an identity of the electrical device and a location of the electrical device, and wherein the method further comprises providing the location from a location component located within the electrical device to the identification component.

3. The method of claim 1, wherein the location component is selected from the group consisting of a Global Positioning System (GPS) unit and an input device.

4. The method of claim 1, wherein the authentication component is located within the electrical device, and wherein the electrical device is connected to the power delivery network via a power socket.

5. The method of claim 1, further comprising authenticating the electrical device on the authentication server using the at least one attribute of the electrical device.

6. The method of claim 5, further comprising activating the electrical device over the power delivery network after the authenticating.

7. The method of claim 1, further comprising:
storing a result of the authenticating in a database; and
storing information pertaining to the electrical device in the database.

8. The method of claim 1, wherein the electrical device utilizes a data networking protocol, and wherein the data networking protocol comprises 802.1X.

9. A method for managing an electrical device over a power delivery network, comprising:
receiving a query within an identification component located within the electrical device from an authentication component located within the power delivery network;
providing an identity of the electrical device from the identification component to the authentication component; and
providing the identity of the electrical device and an identity of a power socket of the power delivery network to which the electrical device is connected from the authentication component to an authentication server over the power delivery network.

10. The method of claim 9, where the authentication component is located within the power socket.

11. The method of claim 9, further comprising:
receiving the identity of the power socket in a location component contained on the authentication server; and
determining a location of the power socket by accessing a power socket location database.

12. The method of claim 11, further comprising authenticating the electrical device on the authentication server based on the location of the power socket and the identity of the electrical device.

13. The method of claim 12, further comprising activating the electrical device over the power delivery network after the authenticating.

14. The method of claim 12, further comprising:
storing a result of the authenticating in a devices information database; and
storing information pertaining to the electrical device in the devices information database.

15. The method of claim 9, wherein the electrical device utilizes a data networking protocol, and wherein the data networking protocol comprises 802.1X.

16. A system for managing an electrical device over a power delivery network, comprising:
an identification component located within the electrical device for receiving a query from an authentication component;
a location component located within the electric device for providing a location of the electrical device to the identification component; and
an authentication component located within the electrical device for receiving an identity of the electrical device and the location of the electrical device from the identification component, wherein the authentication component provides the identity and the location to an authentication server over the power delivery network.

17. The system of claim 16, wherein the location component comprises a Global Positioning System (GPS) unit.

18. The system of claim 16, wherein the authentication server authenticates the electrical device using the location and the identity.

19. The system of claim 16, wherein the electrical device utilizes a data networking protocol, and wherein the data networking protocol comprises 802.1X.

20. The system of claim 16, wherein the location component, the identification component, and the authentication component are each implemented using technology selected from the group consisting of hardware, software, or a combination of hardware and software.
